(19) United States
(12) Patent Application Publication
(10) Pub. No.: US 2025/0162489 A1
(43) Pub. Date: May 22, 2025

(54) Ratcheting Device with a Safe Damping Mechanism and its Use Method

(71) Applicants: Zhengwu SONG, Ningbo (CN); Ningbo Yinzhou Xinda Vehicle Accessories Factory, Ningbo (CN)

(72) Inventors: Zhengwu SONG, Ningbo (CN); Zhengbao JIN, Ningbo (CN)

(73) Assignees: Zhengwu SONG, Ningbo (CN); Ningbo Yinzhou Xinda Vehicle Accessories Factory, Ningbo (CN)

(21) Appl. No.: 18/515,377

(22) Filed: Nov. 21, 2023

(51) Int. Cl. B60P 7/08

(52) U.S. Cl. CPC B60P 7/083; B60P 7/0853

(57) ABSTRACT

The invention discloses a ratcheting device with a safe damping mechanism. It has a base plate and side plates. A central shaft holds a wrenching handle and a ratchet, webbing is rolled around the central shaft; a coiling spring is on one side of the central shaft; a lock plate on side plates stops the ratchet from rotating in a pay-out direction; a drive plate on wrenching handle can drive the ratchet rotates in a retracting direction. The side plates have slide groove and release protrusion section. When the drive plate is in the slide groove, the webbing can be retracting by moving the handle; when drive plate is in the release protrusion section, the webbing can be released or retracting freely. A damping mechanism on the central shaft provides resistance to the safe retraction of the webbing.

### FIELD OF THE INVENTION

The present invention relates to a device for binding goods on a vehicle or transport equipment, especially to a ratcheting device with a safe damping mechanism and its use method.

### BACKGROUND OF THE INVENTION

When transporting goods, it is necessary to secure and tighten them using strap to prevent them from shifting or falling during transit. Manual strapping methods have drawbacks such as being cumbersome and not providing sufficient tension. Nowadays, the use of ratchet tie down with a simple structure aid in the strapping process. These ratchets are directly mounted on vehicles and other transport equipment. However, a disadvantage of these ratchets is that the excess strap or rope cannot be retracted into the ratchet. After tightening the strap to secure the cargo, the surplus portion remains exposed, requiring manual bundling and tidying to avoid loosening or affecting driving.

For this reason, people have thought of many solutions to solve this problem. A patent document with the Ser. No. 10/086,744 in the United States discloses an automatic tightening device with rolling and unrolling control functions.

A handle, a base, and a spool are pivotally connected together by a reel having an associated relationship with the spool and provided with a coil spring driving structure at an end. The handle and the base each has two parallel sidewalls. A movable pawl/stop pawl is mounted between the sidewalls of the handle/base. The two pawls can be in contact with any tooth around ratchet wheel sheets. A no-load webbing unrolling-rolling-stopping region, a safe lock position, a tightening operation region, and a load releasing region are provided at an edge of the base. The no-load webbing unrolling-rolling-stopping regions at the edges of the base are inclined surfaces, end surfaces of the stop and movable pawls are chamfers, and a no-load releasing cam rim and a load releasing cam rim are provided at an edge of the handle.

This solution has rolling and unrolling control functions, an edge of a base is provided with a no-load webbing unrolling-rolling-stopping region, a safe lock position, a tightening operation region, and a load releasing region, when the movable pawl in the handle cooperates with the no-load webbing unrolling-rolling-stopping regions of the base, and when the handle is pressed against the base, or the movable pawl is pulled and the handle is pressed, long webbing can be rolled up by the spool under the action of the coil spring force; and when the force, with which the handle is pressed against the base, is released, or the force, with which the movable pawl is pulled and the handle is pressed, is released, the stop pawl and the movable pawl are brought into contact with the circumference of the spool, and the automatic rolling of the long webbing is stopped. When the movable pawl in the handle is located at the safe lock positions at the edges of the base, the whole handle cannot be swung around the base, and the safe strapping function is achieved in a load state. This greatly improves the efficiency of strapping and the convenience and safety of operation.

However, there are still some shortcomings in this solution. Firstly, the end of the strap typically features a metal buckle, but this solution lacks a damping structure for slowing down the retraction of the strap. This can result in the end of the strap with the metal buckle accelerating during retraction, potentially causing serious harm to the operator, or hit the vehicle or cargo. Additionally, this solution includes four positions: the empty strap unspooling stop zone, the secure locking position, the tightening operation zone, and the unloading zone, which represent four different operational modes. This complexity makes it difficult to manage and can have a negative impact on work efficiency.

A patent document with the number 7503736 in the United States discloses a retractable tie-down provides an adjustable strap under control of a rotation brake during retraction and pay-out. The rotation brake impedes rotation of a spool on which the strap is wrapped and unwrapped during retraction and pay-out of the strap as the tie-down operates in one of either a pay-out mode or a retraction mode. Thus, the rate of retraction of the strap is user-controlled through the rotation brake.

This solution, with the inclusion of a rotating brake, does address the issue of the rapid retraction of the metal buckle to some extent. However, the retraction speed of the strap with metal buckle is still determined by the force applied by the operator depressing the release button. When the release button is pressed, the retraction action will start rapidly, and the said brake cannot effectively control the retraction speed. When the release button is quickly and fully pressed, the strap with metal buckle may still retract rapidly. Additionally, the structural complexity of this solution remains high, resulting in a higher likelihood of malfunctions and making the operation inconvenient.

### BRIEF SUMMARY OF THE INVENTION

This invention provides a ratcheting device with a safe damping mechanism, comprising a U-shaped frame, the base having a base plate and side plates extending in the same direction from the opposite sides of the base plate. In the center of the side plates, there is a central shaft, on which a wrenching handle and a ratchet are placed. The webbing is wound around the central shaft. At one end of the central shaft, there is a coiling spring component, and there is a lock plate that prevents the ratchet from rotating in a pay-out direction.

On the wrench handle, there is a drive plate that can drive the ratchet rotates in a retracting direction. The edge of the side plates has a slide groove, a release protrusion section located at one end of the slide groove near the lock plate. The radius of the slide groove is smaller than the release protrusion section. When the drive plate is in the slide groove, it can retract the webbing by push and pull the wrench handle. When the drive plate is in the release protrusion section segment, the webbing can be retracted or released freely.

Additionally, there is a safe damping mechanism on the central shaft that provides self-control resistance for the retraction of the webbing, helping to control the speed of retraction always within a safe limit through the whole retraction process.

### BRIEF DESCRIPTION OF THE DRAWINGS

To provide a clearer explanation of the technical solution in this application, the following will briefly introduce the drawings that are required for the embodiments. It is evident that the drawings described below are only some embodiments of this application. For those skilled in this field, additional drawings can be obtained based on these drawings without the need for creative effort.

FIG. 1 is a schematic diagram 1 of a ratcheting device with a safe damping mechanism.

FIG. 2 is a schematic diagram 2 of a ratcheting device with a safe damping mechanism.

FIG. 3 is a schematic diagram 3 of a ratcheting device with a safe damping mechanism.

FIG. 4 is a schematic diagram 4 of a ratcheting device with a safe damping mechanism.

FIG. 5 is an exploded view of the ratcheting device with a safe damping mechanism.

FIG. 6 is a schematic diagram of the wrenching handle.

FIG. 7 is a schematic diagram of the ratchet.

FIG. 8 is a schematic diagram 1 of base plate.

FIG. 9 is a schematic diagram 2 of base plate.

FIG. 10 is a schematic diagram of the webbing securing portion and the ratchet.

FIG. 11 is a cross-sectional view of the webbing securing portion.

FIG. 12 is a schematic diagram of another embodiment provided by the present invention.

FIG. 13 is another schematic diagram of FIG. 1.

FIG. 14 is a schematic diagram 2 of the base plate in FIG. 12.

FIG. 15 is a schematic diagram 2 of the wrenching handle in FIG. 12.

FIG. 16 is a schematic diagram 2 of the ratchet in FIG. 12.

In the Figures:
1000 base; 1100 Base Plate; 1110 Extension of the base plate; 1111 lock plate positioning hole; 1120 lock plate; 1121 lock plate positioning part; 1130 fixing hole; 1200 side plates; 1210 slide arc groove; 1220 release protrusion section; 1230 lock plate limiting groove; 1240 drive plate limiting groove; 1300 shield; 1310 belt through hole; 1320 Protective shell; 1400 webbing fixing shaft; 1500 observation ports; 2000 central shaft; 2100 wrenching handle; 2110 drive plate; 2111 drive plate positioning section; 2112 Pressing part; 2113 second protective sleeve; 2120 wrenching part; 2121 first protective sleeve; 2130 wrenching extension part; 2140 drive plate positioning hole; 2150 flat swivel part; 2160 raised part; 2200 ratchet; 2201 fitting part; 2210 wheel body; 2220 wheel teeth; 2300 damping component; 2301 damper; 2302 damper box; 2400 coiling spring component; 2401 coiling spring; 2402 coiling spring box; 2500 belt fixing part; 2501 protruding section; 3000 first elastic element; 3100 second elastic element; 4000 Steel ball component; 4100 Steel ball; 4101 First through hole; 4102 Second through hole; 4103 Third through hole; 4200 Third elastic element; 4300. Steel ball box; 4400 Steel ball storage groove

### DETAILED DESCRIPTION OF THE PREFERRED EMBODIMENT

The following will provide a clear and complete description of the technical solution in the embodiments of this application, in conjunction with the accompanying drawings. Clearly, the described embodiments are only a part of the embodiments within this application, and not the entirety of them. Based on the embodiments within this application, all other embodiments obtained by those skilled in the field without exercising creative effort fall within the scope of protection of this application.

When this document mentions ‘embodiment’ or ‘implementation,’ it means that the specific features, structures, or characteristics described in conjunction with the embodiment or implementation can be included in at least one embodiment within this application. The use of this phrase at various points in the specification does not necessarily refer to the same embodiment, nor is it an independent or alternative embodiment that is mutually exclusive with other embodiments. Those skilled in the art will explicitly and implicitly understand that the embodiments described herein can be combined with other embodiments.

In this specification, for the sake of convenience, words or phrases indicating direction or positional relationships such as ‘middle,’ ‘top,’ ‘bottom,’ ‘front,’ ‘back,’ ‘vertical,’ ‘horizontal,’ ‘upper,’ ‘lower,’ ‘inner,’ ‘outer,’ etc., are used with reference to the position relationship of components as shown in the drawings. This is done to facilitate the description in this specification and simplify the explanation. It does not imply that the devices or elements being referred to must have specific orientations, be constructed, or operated in specific orientations. Therefore, these words or phrases should not be understood as limiting the disclosure. The positional relationships of components can be appropriately changed based on the orientation of the components as described. Consequently, the terms used in the specification are not limited to the words or phrases specifically mentioned and can be changed as appropriate depending on the context.

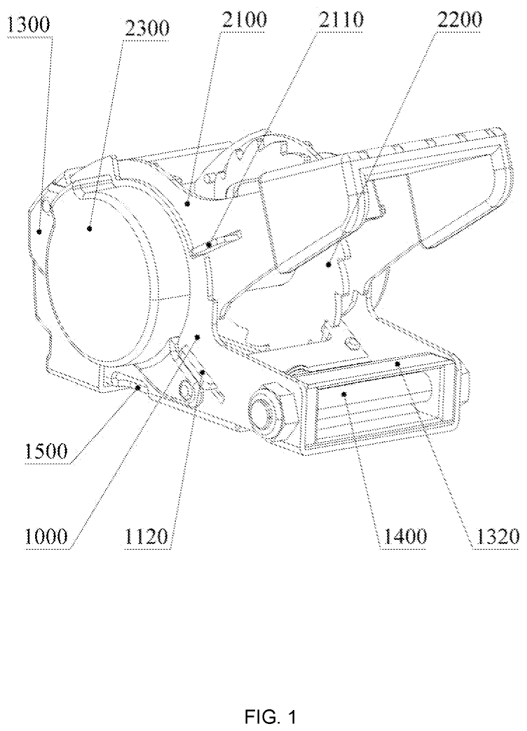

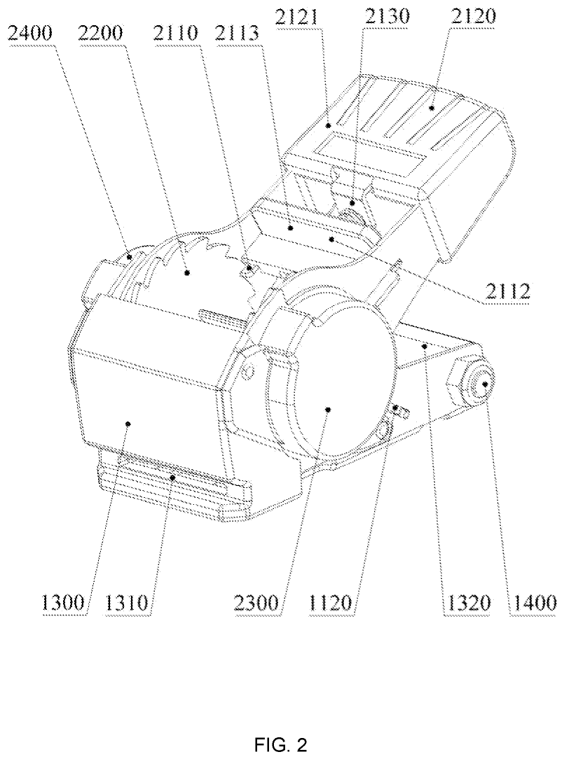

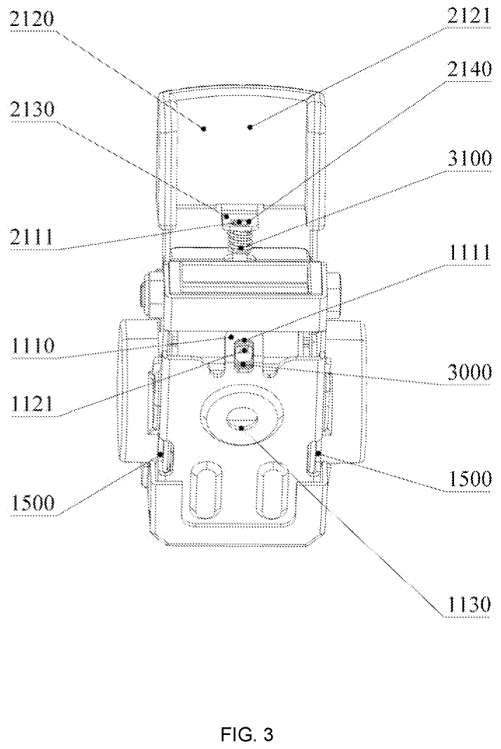

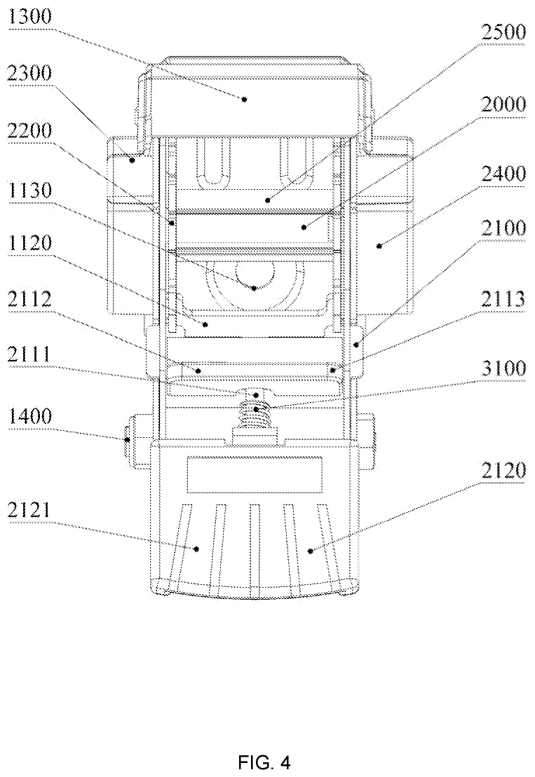

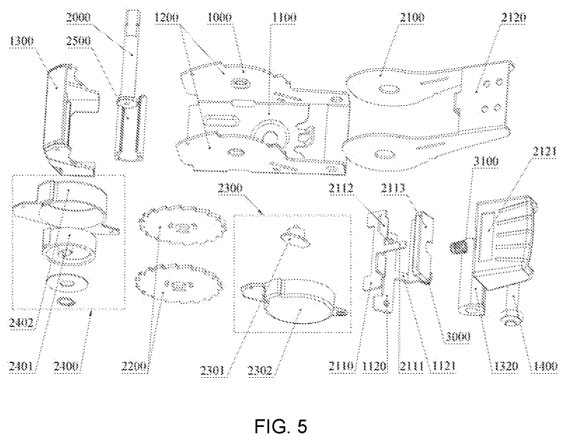

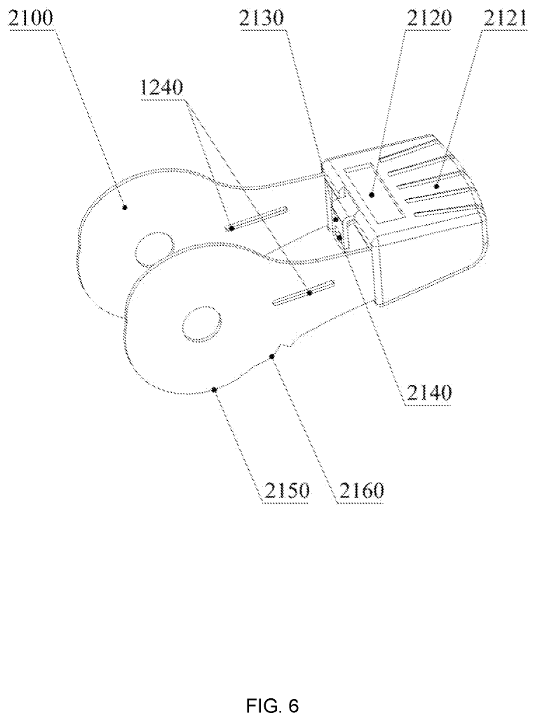

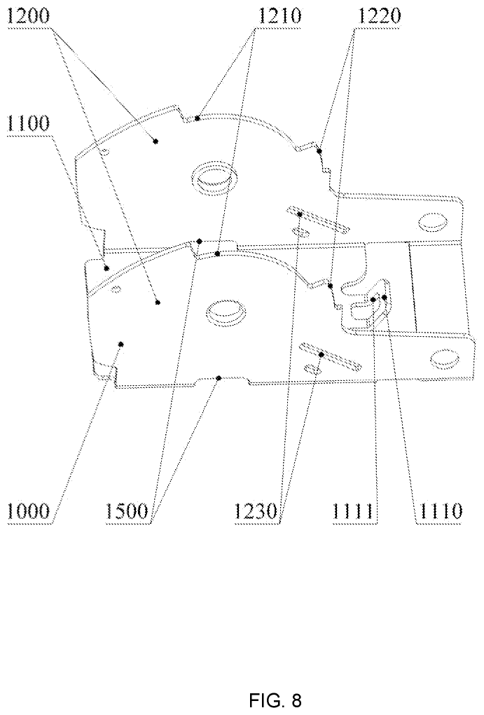

As shown in FIGS. 1 to 9, the present invention provides a ratcheting device with damping, comprising a U-shaped frame 1000, The base 1000 has a base plate 1100 and side plates 1200 extending in the same direction from the opposite sides of the base plate 1100, in the center of the side plates 1200, there is a central shaft 2000, on the central shaft 2000, there is a wrenching handle 2100 and a ratchet 2200; webbing is wound around the central shaft 2000; at one end of the central shaft 2000, there is a coiling spring component 2400, and at the bottom of the side plates 1200, there is a lock plate 1120 that prevents the ratchet 2200 from rotating; on the wrenching handle 2100, there is a drive plate 2110 that can drive the ratchet 2200 to rotate in a retracting direction. The edge of the side plates 1200 has a slide arc groove 1210, with a release protrusion section 1220 located at one end of the slide arc groove 1210 near the lock plate 1120. The radius of the slide arc groove 1210 is smaller than the radius of the release protrusion section 1220. When the drive plate 2110 is inside the slide arc groove 1210, it can retract the webbing by driving the wrenching handle 2100 through the ratchet 2200; when the drive plate 2110 is in the release protrusion section 1220 segment, the webbing can be retracted or released freely; additionally, there is a safe damping mechanism 2300 on the central shaft 2000 that provides safe resistance for the retraction of the webbing.

In this embodiment, the coiling spring component 2400 comprises a coiling spring 2401 and a coiling spring box 2402 set on the coiling spring 2401. The central shaft 2000 has a first end and a second end opposite the first end. The inner hook of the coiling spring 2401 is connected to the first end of the central shaft 2000, and the outer hook of the coiling spring 2401 is connected to the coiling spring box 2402. The coiling spring box 2402 is fixed to the side plates 1200 by rivets.

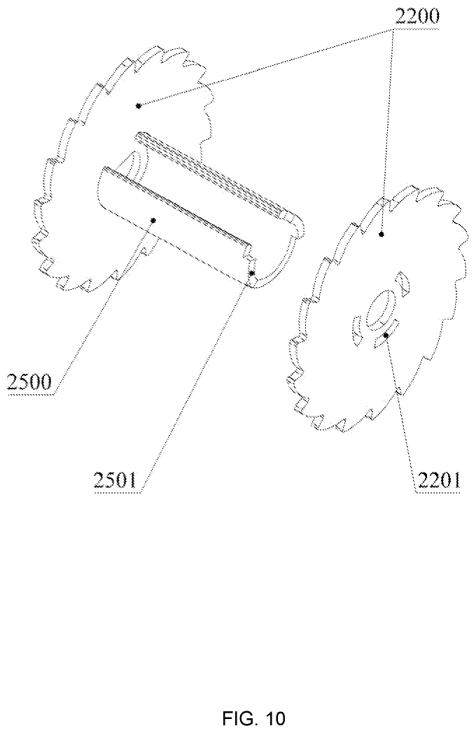

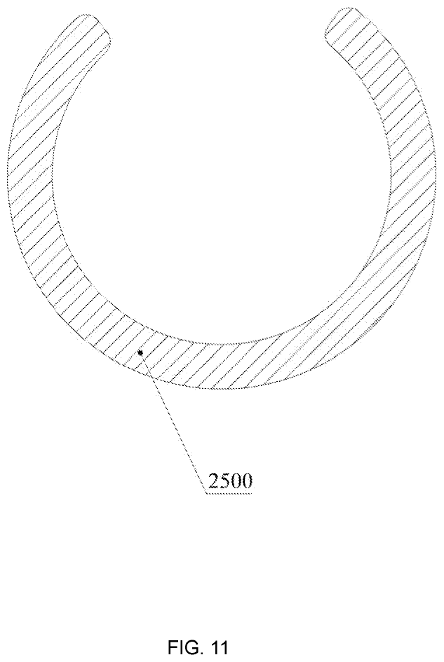

As shown in FIGS. 10 to 11, in this embodiment, the central shaft 2000 also has a belt fixing part 2500 for securing the webbing. The belt fixing part 2500 has a generally ‘U’-shaped cross-section.

On the belt fixing part 2500, there is a protruding section 2501, and on the ratchet 2200, there is a corresponding fitting part 2201 for the protruding section 2501. The belt fixing part 2500 is detachably attached to the ratchet 2200 by interlocking the protruding section 2501 and the fitting part 2201.

In other embodiments (not shown in the figure), the webbing fixing portion is not limited to having a generally ‘U’-shaped cross-section; it can also be designed in circular, elliptical, rectangular, or any desired geometric shape.

In other embodiments (not shown in the figure), the webbing fixing portion and the ratchet are not limited to being detachably attached through interlocking; they can also be designed for detachable attachment through screw connections, hook and loop connections, pin connections, or any desired connection method. In other embodiments (not shown in the figure), the webbing fixing portion and the ratchet are not limited to detachable attachment; they can also be designed for fixed connection, folding connection, or any desired connection method.

In this embodiment, the damping component 2300 comprises a damper 2301 and a damper box 2302 set outside of the damper 2301. The damper 2301 is connected to the second end of the central shaft 2000, and the damper box 2302 is fixed to the side plates 1200, by rivets.

In other embodiments (not shown in the figure), the coiling spring box is not limited to being fixed to the side plates by rivets, and the damper box is not limited to being fixed to the side plates, away from the coiling spring component, by rivets. They can also be designed for attachment using screw connections, pin connections, or any desired connection method.

In this embodiment, the coiling spring component 2400 provides a self-controlled retraction force to retracting the webbing, and the damping component 2300 dynamically provides resistance to partially counteract the retraction force of the coiling spring component 2400. This ensures that the retraction speed of the webbing always be controlled within a safe limit through the whole retraction process. Webbing retracting at high speeds can pose a risk of injury to the operator and those nearby. The self-controlled damping component 2300 significantly enhances the safety of the ratcheting device provided by the present invention.

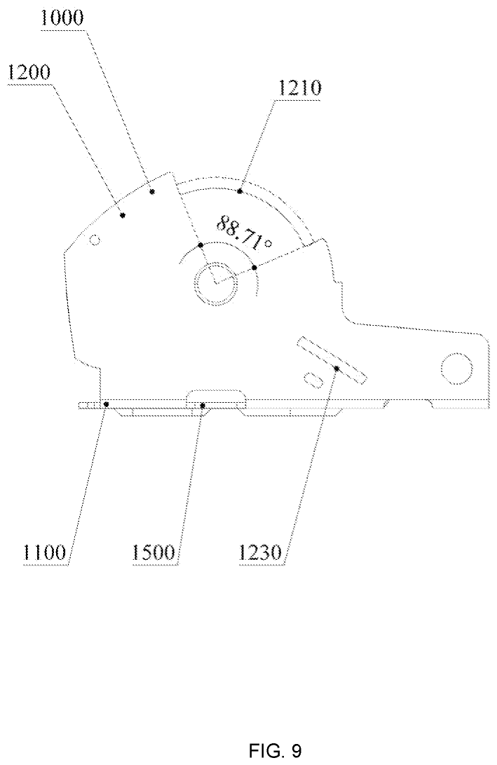

As shown in FIG. 9 in this embodiment, the slide arc groove 1210 includes a starting position and an ending position. The angle between the starting position and ending position relative to the central shaft 2000 is α, where 15°≤α≤150°. In other embodiments (not shown in the figure), the angle α between the starting position and ending position relative to the central shaft is not limited to 15°≤α≤150°; it can also be set to 0°≤α≤180°, 10°≤α≤270°, 30°≤α≤90°, or any desired range of angles.

As shown in FIGS. 1 to 9 in this embodiment, the base plate 1100 extends tangentially in the direction of the central shaft 2000, and the extension of the base plate 1110 is equipped with a lock plate positioning hole 1111. Between the extension of the base plate 1110 and the lock plate 1120, a first elastic element 3000 is positioned. The lock plate 1120 has a lock plate positioning part 1121 that can be used to secure the first elastic element 3000. The lock plate positioning part 1121 can be inserted into the lock plate positioning hole 1111. The lock plate 1120 is elastically connected to the base plate 1100 through the lock plate positioning part 1121 and the first elastic element 3000. The base plate 1000 also forms a fixing hole 1130 for securing the ratchet device.

In this embodiment, the first elastic element 3000 is set as a spring coil. In other embodiments (not shown in the figure), the first elastic element is not limited to being a spring coil; it can also be designed as an elastic washer, elastic pin, elastic sleeve, elastic coupling, elastic mount, elastomeric diaphragm, elastomeric rubber, or any other desired elastic component.

As shown in FIGS. 1 to 9 in this embodiment, the side plates 1200 on both sides of the base 1000 form Lock plate limiting groove 1230. The Lock plate limiting groove 1230 are directed towards the central shaft 2000 and extend in a direction perpendicular to the extension direction of the extension of the base plate 1110. The ratchet 2200 has a wheel body 2210 with 15 to 25 wheel teeth 2220 protruding.

The lock plate 1120 is inserted into the lock plate limiting groove 1230, and one end of the lock plate limiting groove 1230 corresponds to the wheel body 2210. The other end of the lock plate limiting groove 1230 extends in a direction away from the ratchet 2200 by a distance not less than the length of one lock plate 1120 and the height of one-wheel teeth 2220. The lock plate 1120 elastically pushes against the ratchet 2200.

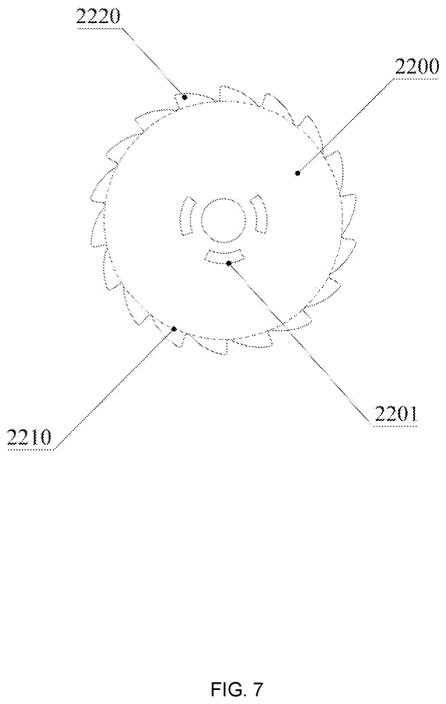

As shown in FIG. 7, in a preferred embodiment, the wheel body 2210 has 18-wheel teeth 2220 protruding. In other embodiments (not shown in the figure), the wheel is not limited to having 15 to 25 wheel teeth; it can also be designed with 12 to 18, 21 to 35, or any desired number of teeth.

In other embodiments (not shown in the figure), the lock plate limiting groove is not limited to being oriented towards the central shaft and extending in a direction perpendicular to the extension direction of the extension of the base plate. It can also be designed to point upwards, downwards, leftwards, rightwards, or in any desired direction.

In other embodiments (not shown in the figure), the lock plate limiting groove is not limited to having one end corresponding to the wheel and the other end extending in a direction away from the ratchet by a distance not less than the length of one lock plate and the height of one wheel tooth. It can also be designed in any desired range.

As shown in FIGS. 1 to 9 in this embodiment, the wrenching handle 2100 has a wrenching part 2120 used for actuating the wrenching handle 2100. The wrenching part 2120 near one end of the central shaft 2000 also has a wrenching extension part 2130 extending vertically and towards the direction of the central shaft 2000. A second elastic element 3100 is positioned between the wrenching extension part 2130 and the drive plate 2110. The wrenching extension part 2130 has a drive plate positioning hole 2140. The drive plate 2110 has a drive plate positioning section 2111, where the drive plate positioning section 2111 can be inserted into the drive plate positioning hole 2140. The drive plate 2110 is elastically connected to the wrenching handle 2100 through the drive plate positioning section 2111 and the second elastic element 3100.

In other embodiments (not shown in the figure), the wrenching extension part is not only positioned at one end of the actuating part near the central shaft and oriented vertically and towards the direction of the central shaft, but it can also be designed to point upwards, downwards, leftwards, rightwards, or in any desired direction.

In this embodiment, the second elastic element 3100 is set as a spring. In other embodiments (not shown in the figure), the second elastic element is not limited to being a spring and can be designed as an elastic washer, an elastic pin, an elastic sleeve, an elastic coupling, an elastic support, an elastic diaphragm, elastic rubber, or any desired elastic element.

As shown in FIGS. 1 to 9 in this embodiment, the side plates 1200 on both sides of the base 1000 respectively form drive plate limiting groove 1240, where the drive plate limiting groove 1240 are oriented towards the direction of the central shaft 2000 and correspond to the direction of the drive plate positioning hole 2140.

Wherein, the drive plate 2110 is inserted into the drive plate limiting groove 1240, where one end of the drive plate limiting groove 1240 corresponds to the slide arc groove 1210, and the other end of the lock plate limiting groove 1230 extends in a direction away from the slide arc groove 1210 by a distance not less than the difference in radius between one drive plate 2110 and one slide arc groove 1210 and the release protrusion section 1220, wherein the drive plate 2110 elastically pushes against the ratchet 2200.

In other embodiments (not shown in the figures), the drive plate limiting groove is not limited to being oriented towards the central shaft and corresponding to the direction of the lock plate positioning hole, and can be set in an upward, downward, leftward, rightward, or any other direction as desired.

In other embodiments (not shown in the figures), the drive plate limiting groove is not limited to having one end corresponding to the slide arc groove, and the other end of the drive plate limiting groove extending in a direction away from the slide arc groove by at least a distance equal to the radius difference between the drive plate and the wrenching arc, but can be set within any range as desired.

In this embodiment, as shown in FIGS. 1 to 9, the wrenching handle 2100 has a flat swivel part 2150 with the center shaft 2000 as the center and a radius smaller than the radius of the ratchet 2200. The flat swivel part 2150 is also provided with a raised part 2160 with a radius not smaller than the radius of the ratchet 2200, and the raised part 2160 is located near one end of the wrenching part 2120.

In this embodiment, as shown in FIGS. 1 to 9, the base 1000 is provided with a shield 1300 at the end near the central shaft 2000. The shield 1300 has a belt through hole 1310. In this embodiment, the material of the shield 1300 is set to plastic. In other embodiments (not shown in the figures), the material of the protective cover is not limited to plastic and can be made of metal, silicone, or any other material as desired.

As shown in FIGS. 1 to 9 in this embodiment, the wrenching part 2120 is equipped with a first protective sleeve 2121. In this embodiment, the material of the first protective sleeve 2121 is set to plastic. In other embodiments (not shown in the figures), the material of the first sheath is not limited to plastic and can be made of metal, silicone, cotton, or any other material as desired.

As shown in FIGS. 1 to 9 in this embodiment, the end of the base 1000 away from the central shaft 2000 is equipped with a webbing fixing shaft 1400, and a protective shell 1320 is also set on the webbing fixing shaft 1400. In some embodiments, there is no protective shell on the webbing fixing shaft. The installation of the protective shell can reduce webbing wear, extend the service life of the webbing, and enhance durability.

In this embodiment, the webbing fixing shaft 1400 is securely connected to the base 1000 using bolts. In other embodiments, the webbing fixing shaft is not limited to being fixed with screws, and can be connected using methods such as pins, rivets, axial connections, or any other desired connection method.

In this embodiment, there are two observation ports 1500 at the bottom of the base 1000, allowing for the observation of the movement of the ratchet 2200. In other embodiments, the number of observation ports is not limited to two and can be set as one, three, four, five, or any desired quantity.

In this embodiment, the drive plate 2110 has a pressing part 2112 that extends vertically to the drive plate 2110 direction and along the direction away from the base 1000, and a second protective sleeve 2113 is placed on the pressing part 2112. In this embodiment, the second protective sleeve 2113 is made of plastic and has anti-slip grooves. In other embodiments, the second protective sleeve is not limited to being made of plastic and can be made from materials such as silicone, metal, wood, or any other desired material.

In this embodiment, when the drive plate 2110 is positioned within the slide arc groove 1210, the drive plate 2110 elastically engages within the slide arc groove 1210 and meshes with the ratchet 2200. Correspondingly, the lock plate 1120 synchronously engages with the ratchet 2200. The wrenching handle 2100 and the base 1000 continuously reciprocate to open and close around the central shaft 2000 through the cooperation of the drive plate 2110 and the lock plate 1120, driving the ratchet 2200 to perform a unidirectional intermittent movement, thereby winding up the webbing to achieve the tightening action. At this point, the webbing cannot be pulled out.

In this embodiment, when the drive plate 2110 is positioned at the release protrusion section 1220, the drive plate 2110 elastically engages with the release protrusion section 1220 and disengages from the ratchet 2200. Correspondingly, the lock plate 1120 is synchronously lifted and disengaged from the ratchet 2200 by the raised part 2160, allowing the ratchet 2200 to rotate freely.

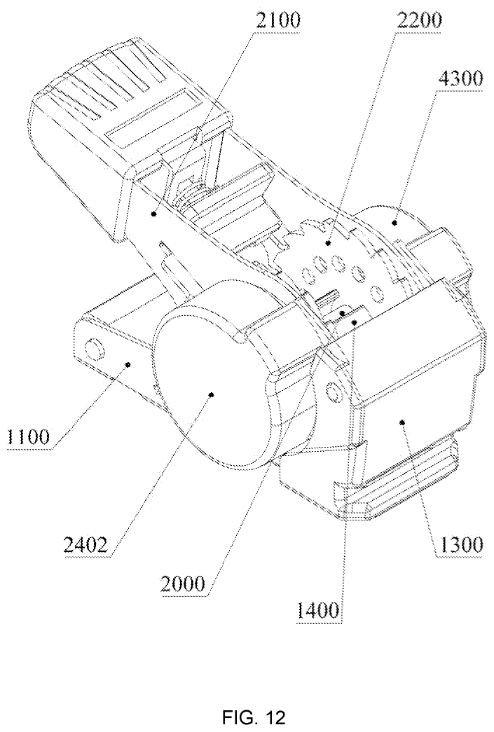

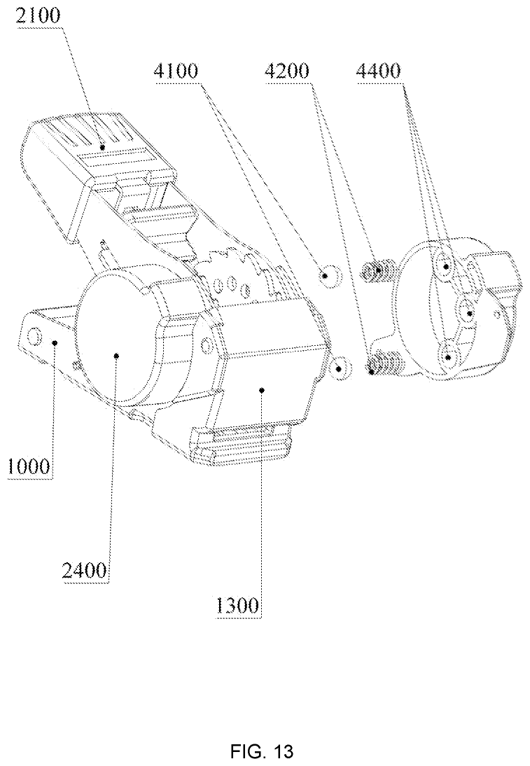

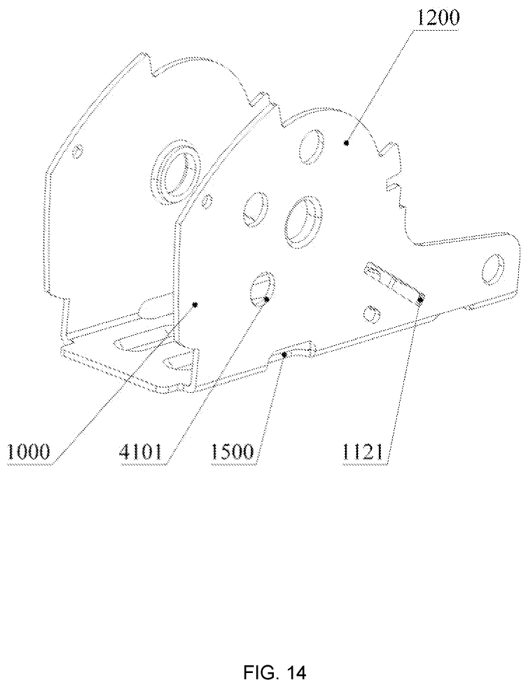

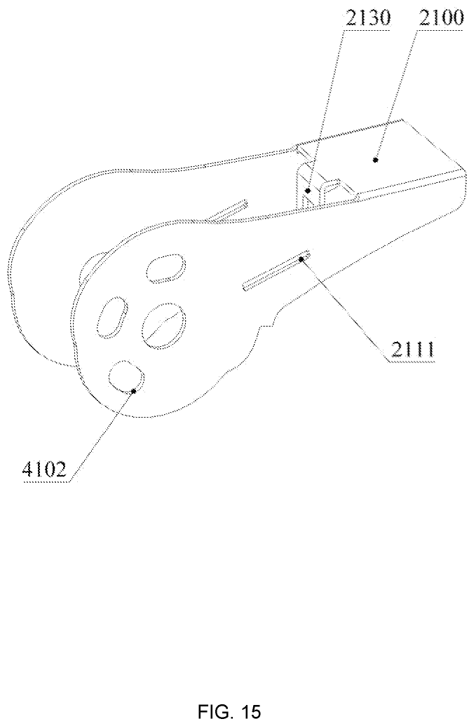

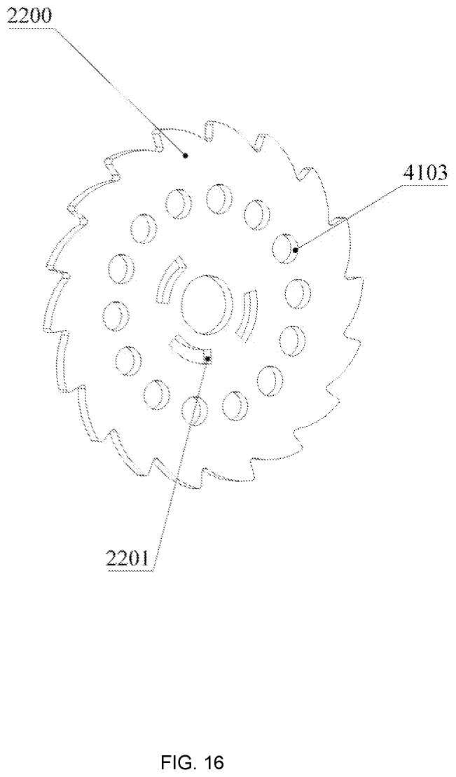

In another embodiment of the present invention, as shown in FIGS. 12 to 16, the difference from the previous embodiment is that the damping component 2300 is replaced with a Steel ball component 4000, which serves the same purpose of providing safe self-control resistance for the retraction of the webbing. Specifically, the Steel ball component 4000 comprises steel balls 4100, a third elastic element 4200, and a steel ball box 4300. Additionally, the steel ball box 4300 is equipped with a steel ball storage groove 4400 to accommodate the steel balls 4100 and the steel ball box 4300.

In this embodiment, two steel balls 4100, two third elastic elements 4200, and three steel ball storage groove 4400 are used. In other embodiments (not shown in the figures), the number of steel balls, third elastic elements, and steel ball housing grooves is not limited to this quantity and can be set as one, four, five, six, or any desired number.

As shown in FIGS. 12 to 16, in this embodiment, there is a first through-hole 4101 in the side plates 1200 of the base 1000 near the Steel ball component 4000. A second through-hole 4102 is set on the actuator 2100 near the Steel ball component 4000, and a third through-hole 4103 is set on the ratchet 2200 near the Steel ball component 4000.

In this embodiment, there are three first through-holes 4101, three second through-holes 4102, and several third through-holes 4103. In other embodiments (not shown in the figures), the first and second through-holes can vary in number, ranging from one, two, four, five, six, or any other quantity as desired.

In this embodiment, the third elastic member 4200 presses against steel balls 4100, passing through the first through-hole 4101 and the second through-hole 4102 before contacting the third through-hole 4103. During the retraction of the webbing, as the ratchet 2200 rotates relative to the wrenching handle 2100, the steel balls 4100 reciprocate through the third through-hole 4103, increasing the resistance to the ratchet 2200's rotation relative to the wrenching handle 2100. This, in turn, slows down the retraction of the webbing.

In another embodiment of the central shaft in the present invention, the internal of the central shaft 2000 is equipped with a cavity, in which a damping component is provided to resist the retraction of the webbing strap, eliminating the need to place the damping component at the end of the central shaft 2000.

This invention also provides a method for using a ratchet device, to provide a ratchet device comprising a base. The base has a central shaft, and on the central shaft, there is a wrenching handle and a ratchet. Webbing is wound around the central shaft. At one end of the central shaft, there is a coiling spring component. At the bottom of the base, there is a lock plate that prevents the ratchet from rotating in a pay-out direction. On the wrenching handle, there is a drive plate that can drive the ratchet rotates in a retracting direction. The edge of the side plates has a slide groove, with a release protrusion section located at one end of the slide groove near the lock plate.

When achieving tightening of the webbing, place the drive plate in the wrenching arcuate groove, and repeatedly push and pull the wrenching handle around the central shaft in a continuous manner.

When achieving free tightening or pulling out of the webbing, place the drive plate in the release protrusion section.

Specifically, when achieving tightening of the webbing, place the drive plate in the wrenching arcuate groove. The resiliently pushing drive plate contacts and engages the ratchet within the wrenching arcuate groove, with the lock plate correspondingly engaging the ratchet. The wrenching handle and base continuously reciprocate around the central shaft in an open and close lever motion. The drive plate and lock plate cooperate to drive the ratchet rotates in a retracting direction, resulting in unidirectional intermittent motion, thereby winding the webbing.

Specifically, when achieving free tightening or pulling out of the webbing, place the drive plate in the release protrusion section. The resiliently pushing drive plate contacts the release protrusion section and disengages from the ratchet, with the lock plate correspondingly pushed away from the ratchet by the wrenching handle. The ratchet can freely rotate in this configuration.

The technical means disclosed in the present invention are not limited to the technical means disclosed in the above-mentioned embodiments but also include technical solutions composed of any combination of the above technical features. It should be noted that those skilled in the field can make various improvements and modifications within the scope of the present invention's principles, and these improvements and modifications are also considered within the scope of the protection of the present invention.

1. A ratcheting device with a safe damping mechanism, comprising:
A U-shaped frame, wherein the frame is provided with a base plate and side plates extending in the same direction of both sides of the base plate, a center shaft is installed in the center of the side plates, and a wrenching handle and ratchet wheel are installed on the center shaft; a webbing is wound around the central shaft; a coiling spring component is installed at one end of the central shaft, and a lock plate capable of preventing the ratchet wheel from rotating in a pay-out direction is installed the side plates; a drive plate on the wrenching handle can drive the ratchet rotates in a retracting direction; and
A slide arc groove section is provided on the edge of the side plates, and a release protrusion section is located at one end of the slide arc groove close to the drive plate, the radius of the slide arc groove is smaller than the radius of the release protrusion section. When the drive plate is in the slide arc groove section, the webbing can be retracting and tighten up through the ratchet by push and pull the wrenching handle; when the drive plate is in the release protrusion section, the webbing can be released or retracting freely. and
Wherein, there is also a safe damping mechanism on the central shaft that provides safe resistance to the retraction of the webbing.

2. The ratcheting device with a safe damping mechanism according to claim 1, characterized in that: the slide arc groove section includes a starting position and an ending position, and the starting position and the ending position are clamped relative to the central shaft, the angle is α, 15≤α≤150°.

3. A ratcheting device with a safe damping mechanism according to claim 2, characterized in that: the base plate extends upwardly to have a base plate extension part, a lock plate positioning hole is provided on the base plate extension part, a first elastic element is provided between the base plate extension part and the lock plate, the lock plate has a lock plate positioning part for fixing the first elastic element, wherein, the lock plate positioning part can be inserted into the lock plate limiting hole, the lock plate forms an elastic connection with the base plate through the lock plate positioning part and the first elastic element.
Wherein, the side plates on both sides of the base plate are respectively formed with limiting groove on side plates.
Wherein, the ratchet has a wheel body, and 15 to 25 wheel teeth are provided on the wheel body;
Wherein, the lock plate is inserted in the lock plate limiting groove on side plates, one end of the lock plate limiting groove on side plates corresponds to the outer periphery of the ratchet wheel, and the other end of the lock plate limiting groove extends a distance not less than one length of the lock plate and one height of the wheel teeth away from the ratchet direction. Wherein, the lock plate elastically pushing the ratchet.

4. A ratcheting device with a safe damping mechanism according to claim 3, characterized in that: the wrenching handle has a wrenching part for wrenching the handle, a wrenching extension part is provided on the wrenching part, an elastic element is provided between the wrenching extension part and the drive plate, a drive plate positioning hole is provided on the wrenching extension part, the drive plate has a drive plate positioning section, wherein, the drive plate positioning section can be inserted into the drive plate positioning hole, the drive plate forms an elastic connection with the wrenching handle through the drive plate positioning section and the second elastic element.
Wherein, the base plate on both sides of the base respectively forms drive plate limiting groove.
Wherein, the drive plate is inserted in the drive plate limiting groove, one end of the drive plate limiting groove corresponds to the slide arc groove, the other end of the drive plate limiting groove extends a distance not less than one length of the drive plate and one radius difference between the slide arc groove and the release drive plate away from the slide arc groove direction, wherein, the drive plate elastically pushes the ratchet.

5. A ratcheting device with a safe damping mechanism according to claim 4, characterized in that: a flat swivel part is provided on the wrenching handle, a raised part is provided at one end of the flat swivel part.

6. A ratcheting device with a safe damping mechanism according to claim 1, characterized in that: a shield is provided at one end of the base close to the central shaft, the shield has a belt through hole.

7. A ratcheting device with a safe damping mechanism according to claim 1, characterized in that: the wrenching handle is provided with a first protective handle sleeve.

8. A ratcheting device with a safe damping mechanism according to claim 1, characterized in that: a webbing fixing shaft is provided at one end of the base away from the center shaft, a protective shell is also provided on the webbing fixing shaft.

9. A ratcheting device with a safe damping mechanism according to claim 1, characterized in that: Through observation ports, the movement of the ratchet is respectively provided on both sides of the bottom of the base.

10. A ratcheting device with a safe damping mechanism according to claim 1, characterized in that: the drive plate has a pressing part perpendicular to the drive plate direction and extending away from the base direction, and a second protective sleeve is provided on the pressing part.

11. A ratcheting device with a safe damping mechanism according to claim 5, characterized in that: when the drive plate is located in the slide arc groove, the drive plate elastically pushes and contacts in the slide arc groove to engage the ratchet, correspondingly the lock plate synchronously engages the ratchet, the wrenching handle and the base continuously open and close around the center shaft, and drive the ratchet rotates in a retracting direction by cooperating with the drive plate and the lock plate, thereby winding the webbing to achieve a retracting or tightening action.

12. A ratcheting device with a safe damping mechanism according to claim 5, characterized in that: when the drive plate is in the release protrusion section, the drive plate elastically pushed outward by release protrusion section to disengage from the ratchet, correspondingly the lock plate is synchronously pushed by the raised part to disengage from the ratchet, the ratchet freely rotates.

13. A ratcheting device with a safe damping mechanism according to claim 13, characterized in that: a webbing fixing part is provided on the outer periphery of the center shaft, the webbing fixing part has a substantially “U” shaped cross section.

14. A ratcheting device with a safe damping mechanism according to claim 13, characterized in that: a protruding section is provided on the webbing fixing part, a fitting part corresponding to the protruding section is provided on the ratchet, wherein, the webbing fixing part and the ratchet are detachably attached by the protruding section and the fitting part.

15. A ratcheting device with a safe damping mechanism according to claim 1 is characterized in that the damping component is integrated with the central shaft to form a central shaft with damping functionality.

16. A method of using a ratchet tie down, characterized in that, providing a ratchet tie down, the ratchet tie down comprising a base, a center shaft is provided at the center of the base, a lock plate and a ratchet are provided on the center shaft; a webbing is wound around the center shaft; a spring assembly is provided at one end of the center shaft, a lock plate for preventing the ratchet from rotating in a pay-out direction is provided at the bottom of the base; a drive plate for driving the ratchet to rotate is provided on the wrenching handle, a slide arc groove is provided at the edge of the side protrusion plates, a release protrusion section is provided at one end of the slide arc groove close to the lock plate.
To tighten the webbing, the drive plate is placed in the slide arc groove, the wrenching handle and the base are continuously opened and closed around the center shaft.
To achieve a free tightening or pulling out of the webbing, the drive plate is placed in the release protrusion section.

17. A method of using a ratchet tie down according to claim 16, characterized in that: To tighten the webbing, the drive plate is placed in the slide arc groove, the drive plate elastically pushes and contacts in the lock plate groove to engage the ratchet, correspondingly the lock plate synchronously engages the ratchet, the wrenching handle and the base continuously open and close around the center shaft, and drive the ratchet rotates in a retracting direction by cooperating with the drive plate and the lock plate, thereby winding the webbing.

18. A method of using a ratchet tie down according to claim 16, characterized in that: when achieving a free tightening or pulling out of the webbing, the drive plate is placed in the release protrusion section, the lock plate elastically pushes out and contacts in the raised part to disengage from the ratchet, correspondingly the lock plate is synchronously pushed by the wrenching handle to disengage from the ratchet, the ratchet freely rotates.
